(19) United States
(12) Patent Application Publication
(10) Pub. No.: US 2002/0112928 A1
(43) Pub. Date: Aug. 22, 2002

(54) Brake cable guide apparatus and method

(75) Inventors: Michael R. Maddux, Kettering, OH (US); Todd A. Kier, Huber Heights, OH (US)

Correspondence Address: SCOTT A. MCBAIN, DELPHI TECHNOLOGIES, INC., Mail Code: 482-204-450, P.O. BOX 5052, 1450 W. Long Lake, Troy, MI, 48098, US

(73) Assignee: DELPHI TECHNOLOGIES INC.

(21) Appl. No.: 10/012,110

(22) Filed: Dec. 7, 2001

Related U.S. Application Data
(60) Provisional application No. 60/270,744, filed on Feb. 22, 2001.

(51) Int. Cl. B60T 1/00

(52) U.S. Cl. 188/2 D; 188/2 R

(57) ABSTRACT

The problem of directing a bullet end of a brake cable, which may have become curved during storage, into seated engagement with a bullet retention slot in a brake apparatus is reduced through the use of a spring affixed to the brake means for guiding the bullet end of the brake cable into seated engagement with the bullet retention slot, as the bullet end is inserted into the brake assembly along an installation path. The spring may also be utilized for retaining the bullet end in seated engagement with the bullet retention slot after installation of the cable.

### RELATED APPLICATIONS

This application claims priority to U.S. patent application Ser. No. 60/270,744 filed on Feb. 22, 2001 entitled “CABLE GUIDE CLIP” by Michael R. Maddux, the entire disclosure of which is incorporated by reference, herein.

### TECHNICAL FIELD OF THE INVENTION

This invention relates to vehicle brakes, and more particularly to cable operated emergency/parking brakes.

### BACKGROUND OF THE INVENTION

A typical vehicle brake system includes an emergency/parking brake apparatus, in which a cable extending from a brake lever or pedal in the vehicle cabin, to one or more of the brake drums or discs, is used to manually apply the brakes. The emergency/parking brake apparatus is used to hold the vehicle in position while it is parked, or to stop the vehicle in the event the primary braking system fails.

As shown in FIG. 1, a typical emergency/parking brake apparatus includes a brake lever 12 including a bullet retention slot 14 adapted to receive a bullet shaped end 16 affixed to the brake cable 18. Once the bullet end 16 is seated in the bullet retention slot 14, the brake can be applied by using the cable 18 to pull on the brake lever 12, and move the brake lever 12 in a manner that applies the brake. To protect the cable 18 from the environment, and to facilitate smooth movement of the cable 18, the cable 18 is typically enclosed within a flexible sheath 20, which is connected to a cage 22 riveted or otherwise attached to the brake lever 12. The sheath 20 shown in FIG. 1 includes a helically wound spring 24 to provide flexibility and support, but other types of sheath construction are also commonly utilized.

During installation of the brake, the bullet end 16 of the brake cable 18 must be fed into the brake assembly past the bullet retention slot 14 and then pulled back into seated engagement with the bullet retention slot 14. As illustrated in FIG. 1, directing the bullet end 16 of the cable into seated engagement with the slot 14 is made more difficult by curvature 26 in the brake cable 18 resulting from the cable 18 being stored in a coiled position prior to installation. If the bullet end 16 does not seat properly in the slot 14, proper operation of the emergency/parking brake may be impaired. Dealing with the curvature in the cable 18 in a manner that ensures full seated engagement of the bullet end 16 with the slot 14 makes installation of the brake cable 18 more difficult and time consuming, thereby adding undesired cost to the installation operation.

What is needed, therefore, is an improved apparatus and method for dealing with the curvature of the brake cable 18 during installation in a manner that ensures that the brake cable 18 will be properly attached to the brake apparatus.

### SUMMARY OF THE INVENTION

Our invention provides an improved method and apparatus for guiding the bullet end of a brake cable into seated engagement with a bullet retention slot in the brake assembly, through the use of a spring device affixed to the brake assembly.

In one form of our invention, a brake apparatus includes a brake device having a bullet retention slot adapted for receiving a bullet end affixed to a brake cable. A spring device is affixed to the brake device for guiding the bullet end of the brake cable into seated engagement with the bullet retention slot.

The bullet retention slot may define a seated cable axis, and have a bullet retaining surface. The bullet end may include a shoulder configured for seated engagement against the bullet retaining surface of the slot, with the brake cable extending from the shoulder of the bullet through the bullet retention slot along the seated cable axis.

In forms of our invention where the shoulder of the bullet must travel past the bullet retaining surface along an installation path before moving laterally from the installation path into seated engagement with the bullet retaining surface of the bullet retention slot, the spring device may be adapted for intercepting the bullet end as it travels along the installation path and guiding the bullet end into seated engagement with the bullet retention slot.

The spring device may include a resilient blade segment intersecting the installation path for intercepting the bullet end and guiding the bullet end into seated engagement with the bullet retention slot. The resilient blade segment may be deflectable from an initial position intersecting the installation path, and generate a force when deflected, for urging the bullet end to travel along the installation path and move laterally into seated engagement with the bullet retention slot. The spring device may also be configured for exerting force on the bullet end after the bullet end is in seated engagement with the bullet retention slot, thereby urging the bullet end to remain in seated engagement with the bullet retention slot.

Our invention may also take the form of a method for installing a brake cable using the apparatus described herein.

The foregoing and other features and advantages of our invention will become further apparent from the following detailed description of exemplary embodiments, read in conjunction with the accompanying drawings. The detailed description and drawings are merely illustrative of our invention rather than limiting, the scope of the invention being defined by the appended claims and equivalents thereof.

### BRIEF DESCRIPTION OF THE DRAWINGS

FIG. 1 is an illustration of the problem encountered during installation of a brake cable in a typical prior brake assemble, caused by residual curvature of the cable resulting from storage of the cable in a coiled position prior to installation;

FIG. 2 is an illustration of an exemplary drum brake assembly incorporating a spring device for guiding the brake cable, according to our invention;

FIG. 3 is an enlarged partial view of the embodiment depicted in FIG. 2 with the brake cable properly installed;

FIG. 4 is an enlarged partial view of the embodiment depicted in FIG. 3, showing the spring device prior to installation of the brake cable; and

FIGS. 5 and 6 are a side and an end view of the spring device depicted in FIGS. 2-4.

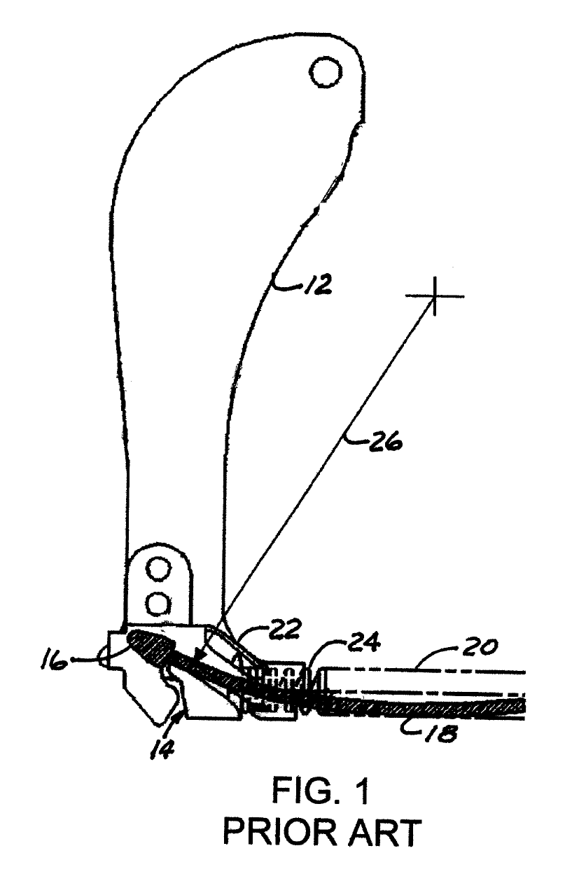

### DETAILED DESCRIPTION OF THE PRESENTLY PREFERRED EMBODIMENTS

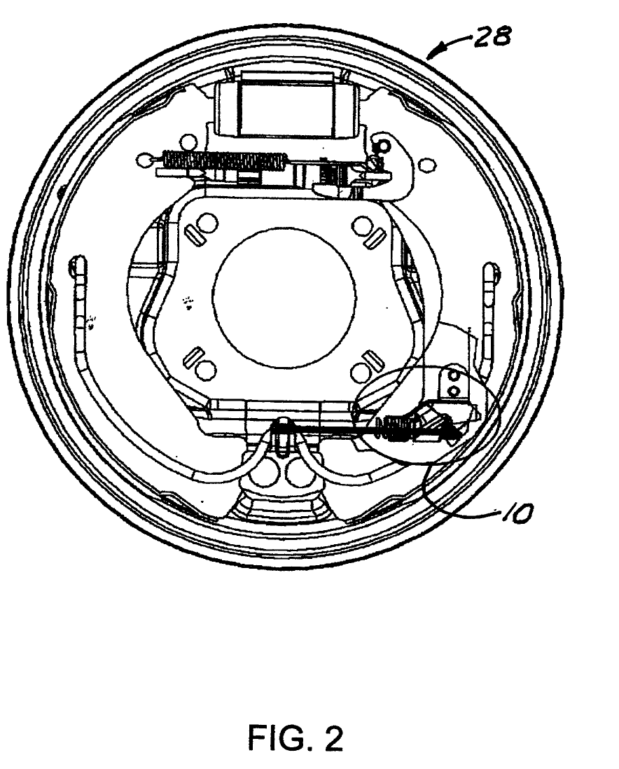

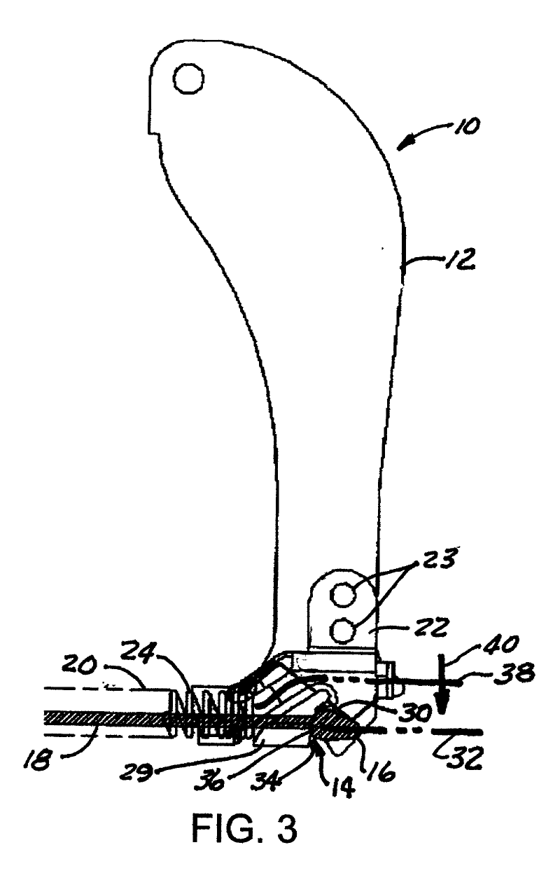

FIGS. 2 and 3 depict a drum brake means 28 having an exemplary form of a brake apparatus 10 according to our invention.

As shown in FIG. 3, the brake apparatus 10 includes a brake lever 12 of the brake means 28, having a lower end 29 (as depicted) formed into a U-shape to provide a bullet retention slot 14 adapted for receiving and retaining a bullet end 16 affixed to a brake cable 18. The brake cable 18 is enclosed within a flexible sheath 20, having a helically wound spring 24, for protecting the cable 18 and ensuring free movement of the cable 18. A cage assembly 22 is attached to the brake lever 12 by rivets 23. The cage assembly 22 is adapted for attachment of the flexible sheath 20, and for guiding the bullet end 16 toward the bullet retention slot 14. A spring means, in the from of a cantilevered leaf spring 30, is attached to the cage assembly 22 for guiding the bullet end 16 of the brake cable 18 into seated engagement with the bullet retention slot 14.

The bullet retention slot 14 defines a seated cable axis 32, and includes a bullet retaining surface 34. The bullet end 16 includes a shoulder 36 configured for seated engagement against the bullet retaining surface 34 of the slot 14, with the brake cable 18 extending from the shoulder 36 of the bullet end 16 through the bullet retention slot 14 along the seated cable axis 32.

The shoulder 36 of the bullet end 14 must travel past the bullet retaining surface 34 along an installation path, illustrated by dashed line 38 in FIG. 3, before moving laterally, as indicated by arrow 40, from the installation path 38 into seated engagement with the bullet retaining surface 34 of the bullet retention slot 14. The spring 30 is adapted for intercepting the bullet end 16 as it travels along the installation path 38 and guiding the bullet end 16 into seated engagement with the bullet retention slot 14.

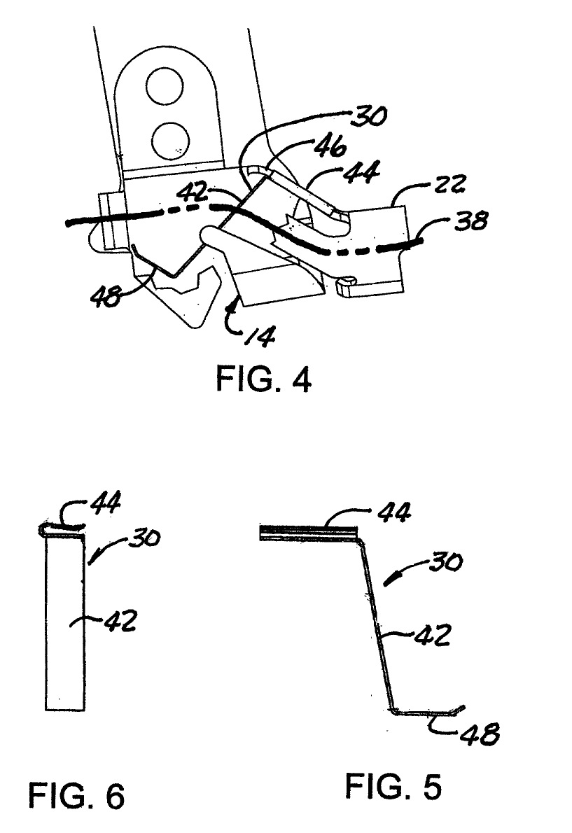

As shown in FIGS. 4-6, the spring 30 is a leaf spring, which may be formed from a metal such as stainless steel or plated spring steel, and includes a resilient blade segment 42 intersecting the installation path 38 for intercepting the bullet end 16 and guiding the bullet end 16 into seated engagement with the bullet retention slot 14. One end of the spring 30 is formed into a U-shaped attachment segment 44 adapted for attachment of the spring 30 to the brake means 28, with the resilient blade segment 42 extending in a cantilevered manner from the attachment segment 44.

In the exemplary form of the invention illustrated in the drawings, the brake apparatus 10 includes the cage 22. The cage 22 has an upturned lip 46, The upturned lip 46 and spring 30 are mutually adapted such that the U-shaped attachment segment 44 of the spring 30 slides over and grips the upturned lip 46, thereby attaching the spring 30 in a cantilevered manner from the upturned lip 46, and properly positioning the resilient blade segment 42 of the spring 30 to intersect the installation path 38.

The distal end 48 of the spring 30 is upturned and extends from the resilient blade segment 42 at an angle thereto selected for precluding seated engagement of the bullet end 16 with the spring 30, as the bullet end 16 travels past the bullet retention slot 14 along the installation path 38, prior to being pulled back along the installation path 38, and moved laterally by the spring 30 into seated engagement with the slot 14.

The resilient blade segment 42 of the spring 30 is deflectable from an initial position, as shown in FIG. 4, intersecting the installation path 38 and generates a force when deflected for urging the bullet end 16 to travel along the installation path 38 and move laterally, as shown by arrow 40 in FIG. 3, into seated engagement with the bullet retention slot 16. In the embodiments depicted in FIGS. 2-6, the spring 30 is configured for exerting force on the bullet end 16 after the bullet end 16 is in seated engagement with the bullet retention slot 14, thereby urging the bullet end 16 to remain in seated engagement with the bullet retention slot 14, as shown in FIG. 3.

Our invention may also be practiced in the form of a method for installing a brake cable 18, where the brake cable has a bullet end 16 adapted for seated engagement into a bullet retention slot 16 of a brake apparatus 28. One form of a method according to our invention includes guiding the bullet end 16 along an installation path 38, and urging the bullet end 16 to move into seated engagement with the bullet retention slot 14 by applying a spring force to the bullet end 16 for directing the bullet end 16 into seated engagement with the bullet retention slot 14. Our method may further include applying spring force to retain the bullet end 16 in seated engagement with the bullet retention slot 14.

Those having skill in the art will recognize that, while we presently consider it preferable to have the components of an assembly 10 according to our invention arranged as described above for a typical drum brake, we wish to expressly state that in other brake means alternate forms of our invention may be utilized within the scope of our invention. Even in drum brakes, those having skill in the art will recognize that the elements and arrangements described herein may be altered considerably within the scope of practicing our invention. For instance, the cage assembly 22 may be eliminated in some embodiments of our invention, and the spring 30 may be configured in a virtually unlimited number of shapes for performing the desired function of guiding the bullet end into seated engagement with the brake means 28. We also expressly wish to state that the term “bullet end” as used herein and in the appended claims is intended to include other types of terminations on brake cables, which may or may not be strictly “bullet shaped” as depicted in the attached drawings.

In summary therefore, while the embodiments of our invention disclosed herein are presently considered to be preferred, various changes and modifications can be made without departing from the spirit and scope of the invention. The scope of the invention is indicated in the appended claims, and all changes or modifications within the meaning and range of equivalents are intended to be embraced therein.

We claim:

1. A brake apparatus comprising:
brake means having a bullet retention slot adapted for receiving and retaining a bullet end affixed to a brake cable; and
spring means affixed to the brake means for guiding the bullet end of the brake cable into seated engagement with the bullet retention slot.

2. The apparatus of claim 1 wherein:
the bullet retention slot defines a seated cable axis and includes a bullet retaining surface; and
the bullet end includes a shoulder configured for seated engagement against the bullet retaining surface of the slot with the brake cable extending from the shoulder of the bullet end through the bullet retention slot along the seated cable axis.

3. The apparatus of claim 2 wherein:
the shoulder of the bullet end must travel past the bullet retaining surface along an installation path before moving laterally from the installation path into seated engagement with the bullet retaining surface of the bullet retention slot; and
the spring means is adapted for intercepting the bullet end as it travels along the installation path and guiding the bullet end into seated engagement with the bullet retention slot.

4. The apparatus of claim 3 wherein the spring means includes a resilient blade segment intersecting the installation path for intercepting the bullet end and guiding the bullet end into seated engagement with the bullet retention slot.

5. The apparatus of claim 4 wherein the resilient blade segment is deflectable from an initial position intersecting the installation path and generates a force when deflected for urging the bullet end to travel along the installation path and move laterally into seated engagement with the bullet retention slot.

6. The apparatus of claim 5 wherein the spring means is configured for exerting force on the bullet end after the bullet end is in seated engagement with the bullet retention slot, thereby urging the bullet end to remain in seated engagement with the bullet retention slot.

7. The apparatus of claim 4 wherein the spring means further includes an upturned end extending from the resilient blade section at an angle thereto and configured for precluding seated engagement of the bullet end with the spring means.

8. The apparatus of claim 4 wherein the spring means includes an attachment segment thereof for attachment of the spring means to the brake means, the resilient blade segment extends in a cantilevered manner from the attachment segment.

9. The apparatus of claim 8 wherein the spring means further includes an upturned end extending from the resilient blade section at an angle thereto and configured for precluding seated engagement of the bullet end with the spring means.

10. The apparatus of claim 8 wherein the resilient blade segment is deflectable from an initial position intersecting the installation path and generates a force when deflected for urging the bullet end to travel along the installation path and move laterally into seated engagement with the bullet retention slot.

11. The apparatus of claim 10 wherein the spring means is configured for exerting force on the bullet end after the bullet end is in seated engagement with the bullet retention slot, thereby urging the bullet end to remain in seated engagement with the bullet retention slot.

12. The apparatus of claim 11 wherein the spring means further includes an upturned end extending from the resilient blade section at an angle thereto and configured for precluding seated engagement of the bullet end with the spring means.

13. The apparatus of claim 8 wherein the brake means further includes:
a brake lever having the bullet retention slot;
a cage assembly attached to the brake lever for guiding the bullet end to the bullet retention slot; and
the attachment segment of the spring means is adapted for attachment to the cage assembly.

14. A brake apparatus comprising:
a brake lever having a bullet retention slot adapted for receiving and retaining a bullet end affixed to a brake cable;
a cage assembly attached to the brake lever for guiding the bullet end to the bullet retention slot; and
a spring means adapted for attachment to the cage assembly for guiding the bullet end of the brake cable into seated engagement with the bullet retention slot.

15. The apparatus of claim 14 wherein:
the bullet retention slot defines a seated cable axis and includes a bullet retaining surface;
the bullet end includes a shoulder configured for seated engagement against the bullet retaining surface of the slot with the brake cable extending from the shoulder of the bullet end through the bullet retention slot along the seated cable axis;
the shoulder of the bullet end must travel past the bullet retaining surface along an installation path before moving laterally from the installation path into seated engagement with the bullet retaining surface of the bullet retention slot; and
the spring means is adapted for intercepting the bullet end as it travels along the installation path and guiding the bullet end into seated engagement with the bullet retention slot.

16. The apparatus of claim 15 wherein the spring means includes:
a resilient blade segment intersecting the installation path for intercepting the bullet end and guiding the bullet end into seated engagement with the bullet retention slot;
an attachment segment thereof for attachment of the spring means to the brake means, the resilient blade segment extending in a cantilevered manner from the attachment segment; and
an upturned end extending from the resilient blade segment at an angle thereto and configured for precluding seated engagement of the bullet end with the spring means.

17. The apparatus of claim 16 wherein the resilient blade segment is deflectable from an initial position intersecting the installation path and generates a force when deflected for urging the bullet end to travel along the installation path and move laterally into seated engagement with the bullet retention slot.

18. The apparatus of claim 17 wherein the spring means is configured for exerting force on the bullet end after the bullet end is in seated engagement with the bullet retention slot, thereby urging the bullet end to remain in seated engagement with the bullet retention slot.

19. A method for installing a brake cable having a bullet end into a bullet retention slot of a brake apparatus, the method comprising:
guiding the bullet end along an installation path; and
urging the bullet end to move into seated engagement with the bullet retention slot by applying a spring force to the bullet for directing the bullet end into seated engagement with the bullet retention slot.

20. The method of claim 19 further comprising applying spring force to retain the bullet end in seated engagement with the bullet retention slot.
